(19) United States
(12) Patent Application Publication
(10) Pub. No.: US 2013/0069436 A1
(43) Pub. Date: Mar. 21, 2013

(54) APPARATUS AND METHOD FOR CONTROLLING POWER OFF IN A MOBILE TERMINAL

(71) Applicants: Bo-Hyun Yu, Uiwang-si (KR); Jong-Hyeok Im, Suwon-si (KR)

(72) Inventors: Bo-Hyun Yu, Uiwang-si (KR); Jong-Hyeok Im, Suwon-si (KR)

(73) Assignee: SAMSUNG ELECTRONICS CO., LTD., SUWON-SI (KR)

(21) Appl. No.: 13/619,217

(22) Filed: Sep. 14, 2012

(30) Foreign Application Priority Data
Sep. 16, 2011 (KR) 10-2011-0093310

(51) Int. Cl. H02J 9/00

(52) U.S. Cl. 307/66

(57) ABSTRACT

An apparatus configured to control power off in an apparatus includes a power unit, a battery detachment detector, an input unit, and a controller. The power unit supplies power from at least one of a battery and an auxiliary power unit. When detecting that the battery is separated from the power unit, the battery detachment detector outputs a battery separation signal to the input unit using power from the auxiliary power unit. When receiving the battery separation signal from the battery detachment detector, the input unit generates a power off event using power from the auxiliary power unit. When the power off event occurs from the input unit, the controller performs a power off procedure using power from the auxiliary power unit.

### CROSS-REFERENCE TO RELATED APPLICATION AND CLAIM OF PRIORITY

The present application is related to and claims priority under 35 U.S.C. §119(a) to a Korean Patent Application filed in the Korean Intellectual Property Office on Sep. 16, 2011 and assigned Serial No. 10-2011-0093310, the contents of which are herein incorporated by reference.

### TECHNICAL FIELD OF THE INVENTION

The present invention generally relates to battery powered devices, and more particularly, to an apparatus and a method for controlling power off in a mobile terminal.

### BACKGROUND OF THE INVENTION

Due to development of electronic communication industries, mobile terminals such as a mobile communication terminals (e.g., cellular phones), electronic schedulers, Personal Digital Assistants (PDAs), etc. have become a necessity of a modem society, and now serve as an important means for efficient transfer of information.

Mobile terminals typically include memory units for storing data. These memory units often include volatile memory elements such as a DRAM, SRAM, etc. and non-volatile memory elements such as EEPROM, FRAM, PRAM, MRAM, flash memory, etc. The volatile memory loses stored data when power is turned off, but the non-volatile memory conserves data even when power is turned off. Generally, the mobile terminal is powered by power from a battery, and the battery can be detachable from the mobile terminal. When sudden power off occurs, that is, the battery is separated during normal operation, the mobile terminal can experience data loss.

### SUMMARY OF THE INVENTION

To address the above-discussed deficiencies of the prior art, it is a primary object to provide to provide at least the advantages described below. Accordingly, an aspect of the present disclosure is to provide an apparatus and a method for controlling power off in order to prevent data loss upon disconnection of a battery from an apparatus, such as a mobile terminal.

Another aspect of the present disclosure is to provide an apparatus for controlling power off, including an auxiliary power unit together with a battery.

Still another aspect of the present disclosure is to provide an apparatus and a method for controlling power off, allowing a normal power off procedure to be performed in the case where battery power is removed from the apparatus.

Yet another aspect of the present disclosure is to provide an apparatus and a method for generating the same power off event as when a power button provided to a mobile terminal is pressed in the case where a battery is suddenly separated during a normal operation of the mobile terminal, and processing the power off event using power from an auxiliary power unit.

In accordance with an aspect of the present disclosure, an apparatus for controlling power off in a mobile terminal in a power-on state includes a power unit configured to supply power from at least one of a battery and an auxiliary power unit, a battery detachment detector configured to, when detecting that the battery is separated from the power unit, output a battery separation signal to an input unit using power from the auxiliary power unit, the input unit configured to, when receiving the battery separation signal from the battery detachment detector, generate a power off event using power from the auxiliary power unit, and a controller configured to, when the power off event occurs from the input unit, perform a power off procedure using power from the auxiliary power unit.

In accordance with another aspect of the present disclosure, a method for controlling power off in a mobile terminal that is being operated, using power of a battery and an auxiliary power unit includes, when detecting that the battery is separated, generating a power off event using power from the auxiliary power unit, and when the power off event occurs, performing a power off procedure using power from the auxiliary power unit.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it can be advantageous to set forth definitions of certain words and phrases used throughout this patent document: the terms “include” and “comprise,” as well as derivatives thereof; mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present disclosure will be more apparent from the following description taken in conjunction with the accompanying drawings in which:

FIG. 1 illustrates an example mobile terminal according to an embodiment of the present disclosure;

FIG. 2 illustrates an example mobile terminal according to an embodiment of the present disclosure;

FIG. 3 illustrates an example procedure for generating a power off event at an input unit according to an embodiment of the present disclosure; and

FIG. 4 illustrates an example procedure for performing a normal power off procedure upon sudden power off at a controller according to an embodiment of the present disclosure.

Throughout the drawings, like reference numerals will be understood to refer to like parts, components and structures.

### DETAILED DESCRIPTION OF THE INVENTION

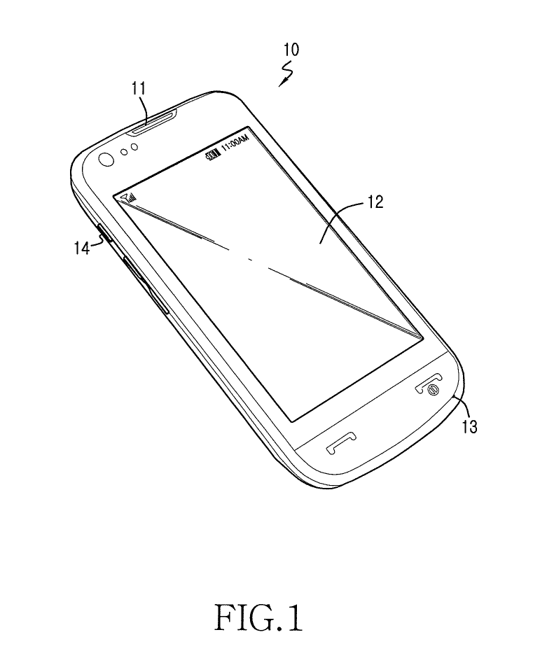

FIGS. 1 through 4, discussed below, and the various embodiments used to describe the principles of the present disclosure in this patent document are by way of illustration only and should not be construed in any way to limit the scope of the disclosure. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

Exemplary embodiments of the present disclosure provide an apparatus and a method for controlling power off, allowing a normal power off procedure to be performed in the case where battery power is turned off abnormally in a mobile terminal. A mobile terminal according to an exemplary embodiment of the present disclosure configures an auxiliary power unit together with a battery, and performs a normal power off procedure using power of the auxiliary power unit in the case where the battery is suddenly separated during a normal operation.

FIG. 1 illustrates an example mobile terminal according to an embodiment of the present disclosure.

Referring to FIG. 1, the mobile terminal 10 includes a speaker 11, a display 12, a microphone 13, and a plurality of buttons. The mobile terminal 10 operates by receiving power from a battery (not shown). The battery can be detachable from the mobile terminal. Furthermore, the mobile terminal 10 further has an auxiliary power unit. In the case where the battery is suddenly separated during normal operation of the mobile terminal, the mobile terminal performs a normal power off procedure using power from the auxiliary power unit. More particularly, in a particular case where the battery is suddenly separated while the mobile terminal 10 is in a power-on state, the mobile terminal 10 generates the same power off event as that when a power button 14 is pressed. Generally, a user turns on or off the mobile terminal 10 by pressing the power button 14. In the case where the battery is mounted, the auxiliary power unit can be charged from the battery.

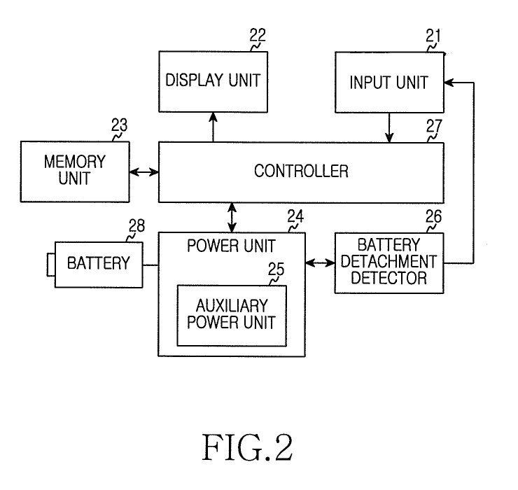

FIG. 2 illustrates an example mobile terminal according to an embodiment of the present disclosure.

Referring to FIG. 2, the mobile terminal includes an input unit 21 for generating an input signal, an output unit 22 for outputting an output signal, a memory unit 23 for storing data, a power unit 24 for supplying power, a battery detachment detector 26, and a controller 27 for controlling an overall operation of the mobile terminal.

The power unit 24 supplies power from at least one of a battery 28 under control of the controller 27, and the auxiliary power unit 25. The auxiliary power unit 25 is charged from the battery 28 when the battery 28 is connected to the mobile terminal 10.

When battery power is not applied to the power unit 24, the battery detachment detector 26 outputs a signal (referred to as a battery separation signal) indicating that the battery 28 is separated to the input unit 21 using power from the auxiliary power unit 25. The input unit 21 receives the battery separation signal from the battery detachment detector 26 and outputs a power off event to the controller 21 using power from the auxiliary power unit 25. In one embodiment, the power off event can be similar to the event generated when the power button 14 of the mobile terminal (of FIG. 1) is pressed. The controller 27 processes the power off event received from the input unit 21 using power from the auxiliary power unit 28.

The battery 28 can include any suitable type of electrical storage cell, such as a lithium-polymer (LiPo) storage cell, a nickel-cadmium (NiCad) storage cell, or a nickel-metal hydride (NiMH) storage cell. Likewise, the auxiliary power unit 25 can also include an electrical storage cell such as described above with respect to the battery 28. Additionally, the auxiliary power unit 25 can include a capacitor for the storage of electrical energy.

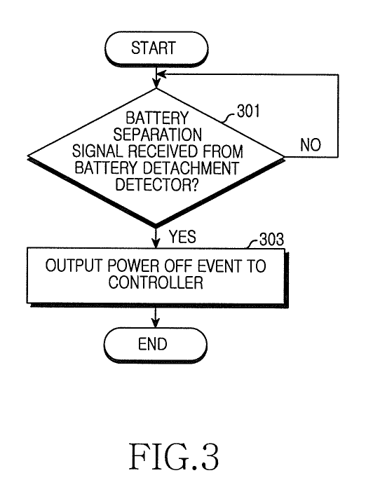

FIG. 3 illustrates an example procedure for generating a power off event at an input unit according to an embodiment of the present disclosure.

Referring to FIG. 3, when receiving a battery separation signal from the battery detachment detector 26 (step 301), the input unit 21 outputs the power off event to the controller 27 (step 303). With the battery 28 separated, the battery detachment detector 26 can output the battery separation signal using power from the auxiliary power unit 25. Furthermore, with the battery 28 separated, the input unit 21 can generate the power off event using power from the auxiliary power unit 25.

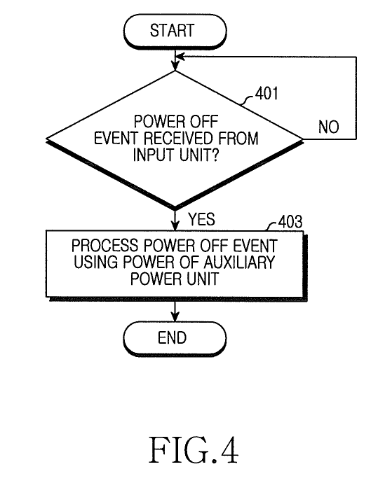

FIG. 4 illustrates an example procedure for performing a normal power off procedure upon sudden power off at a controller occurs according to an embodiment of the present disclosure.

Referring to FIG. 4, when receiving the power off event from the input unit 21, the controller 27 performs powers off the mobile terminal in response to the power off event using the power from the auxiliary power unit 25 (step 403).

Consequently, since the apparatus and the method for controlling power off according to an example embodiment of the present disclosure performs a normal power off procedure using power from the auxiliary power unit in the case where the battery is suddenly separated during a normal operation of the mobile terminal, data loss can be prevented.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

Although the disclosure has been shown and described with reference to certain exemplary embodiments thereof, it will be understood by those skilled in the art that various changes in form and details can be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. An apparatus configured to control a power off event in the apparatus, the apparatus comprising:
a power unit configured to supply power from at least one of a battery and an auxiliary power unit;
a battery detachment detector configured to, when detecting that the battery is separated from the power unit of the apparatus in a power on state, output a battery separation signal to an input unit using power from the auxiliary power unit;
the input unit configured to, when receiving the battery separation signal from the battery detachment detector, generate a power off event using power from the auxiliary power unit; and
a controller configured to, when the power off event occurs from the input unit, perform a power off procedure using power from the auxiliary power unit.

2. The apparatus of claim 1, wherein the auxiliary power unit is configured to be charged from the battery when connected to the power unit.

3. The apparatus of claim 1, wherein the apparatus comprises at least one of a mobile terminal, an electronic scheduler, and a personal digital assistant (PDA).

4. The apparatus of claim 1, wherein the apparatus comprises one or more volatile memory elements.

5. The apparatus of claim 1, wherein the auxiliary power unit comprises a capacitor that is configured to supply electrical power.

6. The apparatus of claim 1, wherein the auxiliary power unit comprises a storage cell.

7. The apparatus of claim 6, wherein the storage cell comprises at least one of a lithium-polymer (LiPo) storage cell, a nickel-cadmium (NiCad) storage cell, and a nickel-metal hydride (NiMH) storage cell.

8. A method for controlling a power off event in the apparatus, the method comprising:
operating the apparatus using power from at least one of a battery and an auxiliary power unit;
when detecting that the battery is separated from the apparatus, generating the power off event using power from the auxiliary power unit; and
when the power off event occurs, performing a power off procedure using power from the auxiliary power unit.

9. The method of claim 8, further comprising when the battery is connected to the apparatus, charging the auxiliary power unit from the battery.

10. The method of claim 8, wherein the apparatus comprises at least one of a mobile terminal, an electronic scheduler, and a personal digital assistant (PDA).

11. The method of claim 8, wherein the apparatus comprises one or more volatile memory elements.

12. The method of claim 8, wherein the auxiliary power unit comprises a capacitor that is configured to supply electrical power.

13. The method of claim 8, wherein the auxiliary power unit comprises a storage cell.

14. The method of claim 13, wherein the storage cell comprises at least one of a lithium-polymer (LiPo) storage cell, a nickel-cadmium (NiCad) storage cell, and a nickel-metal hydride (NiMH) storage cell

15. A power off control means comprising:
means for powering an apparatus using power from at least one of a battery and an auxiliary power unit;
means for, when detecting that the battery is separated from the apparatus, generating a power off event using power from the auxiliary power unit; and
means for, when the power off event occurs, performing a power off procedure using power from the auxiliary power unit.

16. The power off control means of claim 5, further comprising means for, when the battery is connected to the apparatus, charging the auxiliary power unit from the battery.

17. The power off control means of claim 15, wherein the apparatus comprises one or more volatile memory elements.

18. The power off control means of claim 15, wherein the auxiliary power unit comprises a capacitor that is configured to supply electrical power.

19. The power off control means of claim 15, wherein the auxiliary power unit comprises a storage cell.

20. The power off control means of claim 19, wherein the storage cell comprises at least one of a lithium-polymer (LiPo) storage cell, a nickel-cadmium (NiCad) storage cell, and a nickel-metal hydride (NiMH) storage cell.
